(19) United States
(12) Patent Application Publication
(10) Pub. No.: US 2002/0194032 A1
(43) Pub. Date: Dec. 19, 2002

(54) Apparatus for automated risk modification in risk groups

(76) Inventors: Michael Mankopf, Moehrendorf (DE); Volker Schmidt, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 10/159,246

(22) Filed: May 31, 2002

(30) Foreign Application Priority Data
May 31, 2001 (DE) 10126715.0

(51) Int. Cl. G06F 17/60; G06F 19/00

(52) U.S. Cl. 705/3

(57) ABSTRACT

A system for automatic risk modification of a member of a risk group has a data acquisition component which interacts with the member of the risk group to acquire data associated with a risk factor, including repeated acquisition of at least one risk factor parameter. The data are supplied to an expert system which has access to a memory containing a number of product offerings. Based on the transmitted data, the expert system generates an output which includes a behavior recommendation and/or a product offering, having low cost and/or complexity. This recommendation is transmitted to the member of the risk group, and upon the subsequent receipt of a new risk factor parameter from the member, the expert system determines whether modification of the risk factor has occurred. If not, the expert system generates a further output, having a higher cost and/or a higher complexity than the first output, with the procedure being repeated with outputs of stepped incremental complexity or cost levels being supplied to the risk group member as long as no modification of the risk factor is indicated by the risk factor parameter.

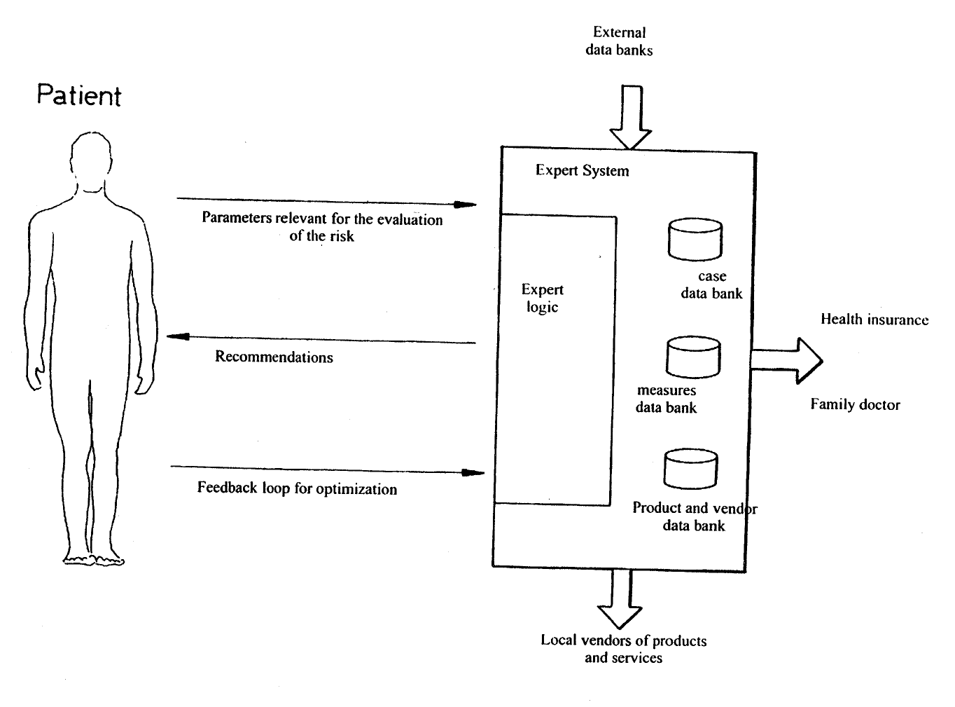

### BACKGROUND OF THE INVENTION

1. Field of the Invention

The present invention is directed to a system for automatic risk modification in risk groups, of the type having acquisition and transmission devices located at the individual members of the risk group (patient) for determining the relevant risk factors and their respective measured values for regular forwarding of risk factors to an expert system which, in combination with data banks regarding possible measures for risk modification, provides the patient with behavior recommendations from an evaluation of the person-related data.

2. Description of the Prior Art

Risk factors such as obesity, malnourishment, lack of movement, nicotine and alcohol misuse, high blood pressure or the like exist in the population that can lead over time to chronic clinical situations such as, for example, diabetes, COLD, cardiac insufficiency, arterial occlusion conditions, stroke, back complaints, joint complaints, lung cancer etc. By modifying the risk factors, the occurrence of these clinical situations can be prevented or temporally delayed Such risk factor modification, however, requires modifications of the life style of persons who typically do not yet notice any disease symptoms and therefore are very difficult to influence.

The key to risk modification is different for each individual. Accordingly, various conventional techniques make use of various approaches to seek norms for risk modifications such as, for example, educational campaigns in the public media or patient information via pharmacists, when visiting a physician, or from the Internet. Moreover, there are numerous other health programs such as, for example, Weight Watchers® that specifically combat the risk factors such as obesity and malnourishment.

U.S. Pat. No. 5,967,789 discloses an apparatus of the type initially described wherein the patient communicates with an expert system that provides the patient with general behavior recommendations on the basis of the patient's specific risk factors. These behavioral recommendations, however, do not include a specific product recommendation as to what the patient should eat and drink nor a behavior recommendation as to the way the patient should engage in physical activity. In particular, no judgment whatsoever is made with regard to how expensive the proposed behavior will be and what costs the health insurance systems, which are interested in such a risk modification system will incur.

An apparatus is disclosed in U.S. Pat. No. 5,486,999 for selecting treatment strategies and behavioral recommendations for patients, wherein the concern is to avoid proposals and treatments that are unsuitable for the specific problem. This system in fact is intended to contribute to cost reduction but does this specifically only by avoiding unsuitable recommendations.

### SUMMARY OF THE INVENTION

An object of the present invention is to design a system of the type initially described wherein the expert system makes an efficacious selection from a number of different, possible behavioral recommendations and products that can assist the patient to modify the patient's risk, in a manner adapted to the patient's situation.

This object is inventively achieved in a system of the type initially described wherein the expert system has data banks in which a number of product offerings are stored and an evaluation device that can evaluate different, possible behavioral recommendations according to the costs incurred and can optimize these recommendations, and wherein the expert system is configured such that it first provides inexpensive behavioral recommendations or product offerings and proposes more complicated and/or more expensive behavioral recommendations or product offerings step-by-step only when follow-up messages indicate a lack of success of earlier pre-recommendations.

In the inventive system, the patient is no longer supplied with a number of behavior recommendation and product recommendations from which the patient must still personally make a selection; rather, a particular behavior is recommended to the patient and a very specific product is offered, these being suited to alleviate the patient's complaints or to reduce the patient's risk, initially with extremely simple and inexpensive recommendations, and more expensive treatment methods and treatment products are only offered and utilized subsequently, in stepped increments, when the less expensive versions prove to be inadequate for the desired purpose of risk alleviation.

The patient (who is only referred to in this way for convenience even though an illness that requires treatment is not yet actually present) or family members, parents or caregivers acquire the respective risk factors, for example blood pressure, physical weight, cigarette consumption, alcohol consumption, complaints relating to mobility or physical performance, etc. with corresponding measuring instruments. These can be measuring instruments in the actual sense such as, for example, devices for measuring blood pressure, scales or the like, but also can be questionnaires with which not only potential risk factors are sought but also with which specific ideals, project goals, preferred foods or the like can also be inquired about. Such inquiries going beyond the risk factor supply significant information for the expert system so that the expert system can prepare recommendations that are individually adapted and come close to certain ideal preconceptions on the part of the patient. Such recommendations that oblige the inclinations of the patient, i.e. for example, nutritional proposals that avoid the inclusion of specific fish dishes when it is known by asking the patient that the patient absolutely never eats fish, have a considerably greater chance of being accepted by the patient, so that the chances for a successful outcome of the automated risk-modification are consequently also increased.

### DESCRIPTION OF THE DRAWING

The single figure is a schematic illustration of a system for automatic risk modification in risk groups constructed and operating in accordance with the principles of the present invention, also schematically indicating interaction with a patient.

### DESCRIPTION OF THE PREFERRED EMBODIMENTS

As shown in the figure, the patient sends the acquired measured values to the central system via the existing transmission devices, for example e-mail, fax, telephone with voice recognition, DTMF, Internet or the like, and the central expert system first places the data into a form that can be processed. As warranted, voice recognition or OCR software can be utilized in order to automatically generate electronically processable data from the information that have been submitted.

The data can be stored in a “health file”. The central expert system process the information and generates a proposal for risk modification that it communicates to the patient, to which end the proposal with behavioral recommendations and/or product offerings must, of course, be brought into a format that the patient can read. The same channels as for the transmission of the data from the patient to the expert system are thereby available as communication channels to the recipient, i.e. e-mail, fax, text 2 speech, web pages, XML, HTML. The expert system preferably generates the proposals in the same format and sends them on the same route over which it received the risk factors and measured values from the patient.

When the patient accepts the proposal and this leads to the desired success, the system recognizes this by monitoring the health parameters that, of course, the patient regularly communicates over and over.

When, however, these parameters do not change in the desired way, then the system generates an alternative proposal and sends it to the affected party (feedback loop).

The generation of a proposal is carried out by an expert system that, in particularly, also can generate proposals for modifying a number of risks. This expert system can be a system that operates with fixed rules or can be a learning system that initially proceeds on the basis of statistical data and learns what combinations of measures lead to success in the case of the individual under consideration. To this end, the expert system accesses various databanks that contain generic measures, and the raw proposals are subsequently adapted, first, to the individual and, second, can be optimized in terms of costs. Individual health data are employed for this purpose, for example data about personal preferences, physical features, measured health parameters, etc.

The expert system then generates the final proposal from the databank with local vendors and their services, this final proposal being capable of being sent to the affected party via various media. As warranted, the expert system also can access pre-existing, expert system modules, via the Internet as well, such as, for example, expert system modules about diet.

In the simplest case, a behavioral recommendation of the expert system can be a specific information for the affected party (similar to educational information—for example: “You are overweight, your personal ideal weight is . . . ”), but also can be a plan of how to bring a health parameter into the desired target range over time. One example is the normalization of blood pressure and of physical weight in a project plan having a constantly more refined sequence of behavioral recommendations:

First proposal:

Enlightening the affected party about his or her individual risk Second proposal:

Dietary plan for weight reduction and restriction of table salt.

Third proposal:

Second proposal plus individually adapted recipes.

Fourth proposal:

Third proposal with additional ordering in the supermarket via the expert system for supplying the corresponding, suitable ingredients.

Fifth proposal:

Like fourth proposal, but with the engagement of a delivery service for food that has already been prepared.

Sixth proposal:

Fifth proposal with an additional motion program.

Seventh proposal:

Sixth proposal as well as the engagement of local vendors of fitness programs from whom, for example, the patient receives a coupon for trial training and a fitness program specifically adapted to the patient.

Specifically given the engagement of local service vendors for supplying foods or for fitness programs, some of the costs of the inventive program can also be borne by these local vendors, whose services can be directly billed to the system. However, health insurers and public health agencies are the ones most interested in such a system, who may save rather substantial funds in the treatment of the diseases potentially resulting from these risk factors as a result of a successful, automated risk modification in risk groups. For this reason, the expert system—of course in consultation with the patient—can initiate forwarding of information to other entities such as health insurers, a family physician or the like.

Although modifications and changes may be suggested by those skilled in the art, it is the intention of the inventors to embody within the patent warranted hereon all changes and modifications as reasonably and properly come within the scope of their contribution to the art.

We claim as our invention:

1. A system for automatic risk modification of a member of a risk group, comprising:
a data acquisition component adapted for interaction with a member of a risk group for acquiring data associated with a risk factor of said member, including repeated acquisition of at least one risk factor parameter from said member; and
an expert system in communication with said data acquisition component, and having access to a data bank in which a plurality of product offerings are stored, said expert system being configured to generate a first output, selected from the group consisting of behavior recommendations and product offerings, dependent on said data, said first output having a characteristic, selected from the group consisting of cost and complexity, at a first level, said expert system communicating said first output to said member and subsequently receiving said risk factor parameter therefrom, and said expert system generating subsequent outputs with said characteristic respectively at stepped increments higher than said first level, if said risk factor parameter indicates a lack of modification of said risk factor resulting from a preceding output.

2. A system as claimed in claim 1 wherein said data acquisition components comprise components for additionally obtaining personal data from said member, selected from the group consisting of ideal preconceptions of said member, project objectives of said member, and eating habits of said member.

3. A system as claimed in claim 1 comprising a communication device for communicating said data from said data acquisition component to said expert system, selected from the group consisting of an e-mail transmission device, a facsimile device, a telephone with voice recognition, DTMF, and the Internet.
